(19) United States
(12) Patent Application Publication
(10) Pub. No.: US 2017/0272925 A1
(43) Pub. Date: Sep. 21, 2017

(54) RECEPTION OF EMERGENCY MESSAGES IN MOBILE DEVICES

(71) Applicant: QUALCOMM Incorporated, San Diego, CA (US)

(72) Inventors: Phaneendra Rupanagudi Venkata, San Diego, CA (US); Sitaramanjaneyulu Kanamarlapudi, San Diego, CA (US); Arvindhan Kumar, San Diego, CA (US); Chetan Gopalakrishnan Chakravarthy, San Diego, CA (US); Neeleshwar Iyer, San Diego, CA (US); Maansi Jain, San Diego, CA (US)

(21) Appl. No.: 15/071,012

(22) Filed: Mar. 15, 2016

(51) Int. Cl. H04W 4/22; H04W 72/10; H04W 76/04; H04L 12/26; H04W 36/26

(52) U.S. Cl. CPC H04W 4/22; H04L 43/16; H04W 36/26; H04W 76/048; H04W 72/10

(57) ABSTRACT

Methods for receiving emergency messages on a mobile communication device having a first subscription and a second subscription sharing a radio frequency (RF) resource may include prioritizing, by a processor of the mobile communication device, the first subscription for a predetermined time period in order to receive an emergency message, determining, by the processor, whether the first subscription should be de-prioritized before the predetermined time period expires based on a reception history of the first subscription during the predetermined time period, and tuning the RF resource to the second subscription before the predetermined time period expires in response to determining that the first subscription should be de-prioritized before the predetermined time period expires.

### BACKGROUND

Some designs of mobile communication devices—such as smart phones, tablet computers, and laptop computers—contain one or more Subscriber Identity Module (SIM) cards that provide users with access to multiple separate mobile telephony networks. Examples of mobile telephony networks include Third Generation (3G), Fourth Generation (4G), Long Term Evolution (LTE), Time Division Multiple Access (TDMA), Code Division Multiple Access (CDMA), CDMA 2000, Wideband CDMA (WCDMA), Global System for Mobile Communications (GSM), Single-Carrier Radio Transmission Technology (1xRTT), and Universal Mobile Telecommunications Systems (UMTS). A SIM may utilize a particular radio access technology (RAT) to communicate with its respective network.

A wireless communication device that includes one or more SIMs and connects to two or more separate mobile telephony networks supporting two or more subscriptions using one or more shared radio frequency (RF) resources/radios may be termed a multi-subscription multi-standby (MSMS) communication device. One example of an MSMS device is a dual-SIM dual-standby (DSDS) communication device, which includes two SIM cards supporting two or more subscriptions that are each associated with a separate radio access technology (RAT). In DSDS communication devices, the separate subscriptions share one RF resource (sometimes referred to as an RF resource chain) to communicate with two separate mobile telephony networks on behalf of their respective subscriptions. When one subscription is using the RF resource, the other subscription is in stand-by mode and is not able to communicate using the RF resource. In a DSDS mobile communication device that has single radio resource to be used by both subscriptions, the radio resources are arbitrated between the two subscriptions based on the priority of activities that occur on the individual subscriptions.

One consequence of having a plurality of subscriptions that maintain network connections simultaneously is that the subscriptions may sometimes interfere with each other's communications. For example, two subscriptions on a DSDS communication device utilize a shared RF resource to communicate with their respective mobile telephony networks, and one subscription may use the RF resource to communicate with the subscription's mobile network at a time. Even when a subscription is in an “idle-standby” mode, meaning that the subscription is not actively communicating with the network, the subscription may continue to periodically obtain access to the shared RF resource in order to perform various network operations. For example, an idle subscription may request access to the shared RF resource at regular intervals to perform idle-mode operations to receive network paging messages in order to remain connected to the network. However, when one subscription has priority over the RF resource the other subscriptions may not be able to remain connected to their respective networks.

### SUMMARY

Various examples of methods for receiving emergency messages on a mobile communication device having a first subscription and a second subscription sharing a radio frequency (RF) resource may include prioritizing, by a processor of the mobile communication device, the first subscription for a predetermined time period in order to receive an emergency message, determining, by the processor, whether the first subscription should be de-prioritized before the predetermined time period expires based on a reception history of the first subscription during the predetermined time period, and tuning the RF resource to the second subscription before the predetermined time period expires in response to determining that the first subscription should be de-prioritized before the predetermined time period expires.

In some examples, the emergency message may be an Earthquake and Tsunami Warning System (ETWS) message or a Commercial Mobile Alert System (CMAS) message. In some examples, the emergency message may include repeated transmissions of one or more message segments, and determining whether the first subscription should be de-prioritized before the predetermined time period expires based on the reception history of the first subscription during the predetermined time period may further include decoding, by the processor, each received message segment, incrementing, by the processor, an associated counter by the processor for each message segment that is successfully decoded, determining, by the processor, whether counters associated with each message segment are each greater than or equal to a threshold, and tuning the RF resource to the second subscription before the predetermined time period expires in response to determining that the counters associated with each message segment are all greater than or equal to the threshold. Some example methods may further include receiving additional repeated transmissions of the one or more unique message segments in response to determining that the counters associated with each message segment are not each greater than or equal to the threshold.

In some examples, the emergency message may include one or more message segments, and determining whether the first subscription should be de-prioritized before the predetermined time period expires based on the reception history of the first subscription during the predetermined time period may further include determining, by the processor, whether a decodable message segment is received during a current frame, incrementing, by the processor, a counter in response to determining that no decodable message segment is received during the current frame, determining, by the processor, whether the counter is greater than or equal to a threshold, and tuning the RF resource to the second subscription before the predetermined time period expires in response to determining that the counter is greater than or equal to the threshold. Some example methods may further include resetting, by the processor, the counter in response to determining that a decodable message segment is received during the current frame. In some examples, the counter may be maintained by a physical layer of the RF resource. In some examples, the predetermined time period may be based on a discontinuous reception scheduling mode of a network associated with the first subscription.

Further examples include a mobile communication device including a memory, an RF resource, and a processor configured to perform operations of the methods summarized above. Further examples include a non-transitory processor-readable storage medium having stored thereon processor-executable software instructions configured to cause a processor of a mobile communication device to perform operations of the methods summarized above. Further examples include a mobile communication device that includes means for performing functions of the methods summarized above.

### BRIEF DESCRIPTION OF THE DRAWINGS

The accompanying drawings, which are incorporated herein and constitute part of this specification, illustrate examples, and together with the general description given above and the detailed description given below, serve to explain the features of the disclosed systems and methods.

FIG. 1A is a timing diagram illustrating an example of transmission intervals in a common traffic channel for use with various examples.

FIG. 1B is a communication system block diagram of mobile telephony networks suitable for use with various examples.

FIG. 2 is a component block diagram of a multi-SIM communication device according to various examples.

FIG. 3 is a timing diagram illustrating conventional reception of an emergency message on a mobile communication device.

FIG. 4 is a timing diagram illustrating adaptive reception of an emergency message on a mobile communication device according to various examples.

FIG. 5 is a timing diagram illustrating another approach for adaptive reception of an emergency message on a mobile communication device according to various examples.

FIG. 6 is a process flow diagram illustrating a method for receiving emergency messages on a mobile communication device according to various examples.

FIG. 7 is a process flow diagram illustrating a method for determining whether a first subscription receiving an emergency message should be de-prioritized before a predetermined time period expires according to various examples.

FIG. 8 is a process flow diagram illustrating another method for determining whether a first subscription receiving an emergency message should be de-prioritized before a predetermined time period expires according to various examples.

FIG. 9 is a component block diagram of a mobile communication device suitable for implementing some example methods.

### DETAILED DESCRIPTION

Various examples will be described in detail with reference to the accompanying drawings. Wherever possible, the same reference numbers will be used throughout the drawings to refer to the same or like parts. References made to particular examples and implementations are for illustrative purposes, and are not intended to limit the scope of the written description or the claims.

As used herein, the term “mobile communication device,” “multi-SIM communication device” or “multi-SIM device” refers to any one or all of cellular telephones, smart phones, personal or mobile multi-media players, personal data assistants, laptop computers, tablet computers, smart books, smart watches, palm-top computers, wireless electronic mail receivers, multimedia Internet-enabled cellular telephones, wireless gaming controllers, and similar personal electronic devices that includes one or more SIM modules (e.g., SIM cards), a programmable processor, memory, and circuitry for connecting to at least two mobile communication network with one or more shared RF resources. Various examples may be useful in mobile communication devices, such as smart phones, and so such devices are referred to in the descriptions of various examples. However, the examples may be useful in any electronic devices that may individually maintain a plurality of RATs that utilize at least one shared RF chain, which may include one or more of antennae, radios, transceivers, etc. Multi-SIM communication devices may be configured to operate in DSDS mode.

As used herein, the terms “SIM module,” “SIM card,” and “subscriber identification module” are used interchangeably to refer to a memory module that may be an integrated circuit or embedded into a removable card, and that stores an International Mobile Subscriber Identity (IMSI), related key, and/or other information used to identify and/or authenticate a multi-standby communication device on a network and enable a communication service with the network. All GSM, UMTS and LTE network mobile phone users have a unique identification associated with them known as an IMSI. Because the information stored in a SIM enables the multi-SIM communication device to establish a communication link for a particular communication service with a particular network, the term “subscription” is used herein as a shorthand reference to refer to the communication service associated with and enabled by the information stored in a particular SIM as the SIM and the communication network, as well as the services and subscriptions supported by that network, correlate to one another.

In the following descriptions of various examples, references are made to a first subscription and a second subscription. The references to the first and second subscriptions are arbitrary and are used merely for the purposes of describing the examples. The device processor may assign any indicator, name, or other designation to differentiate the subscriptions on the mobile communication device.

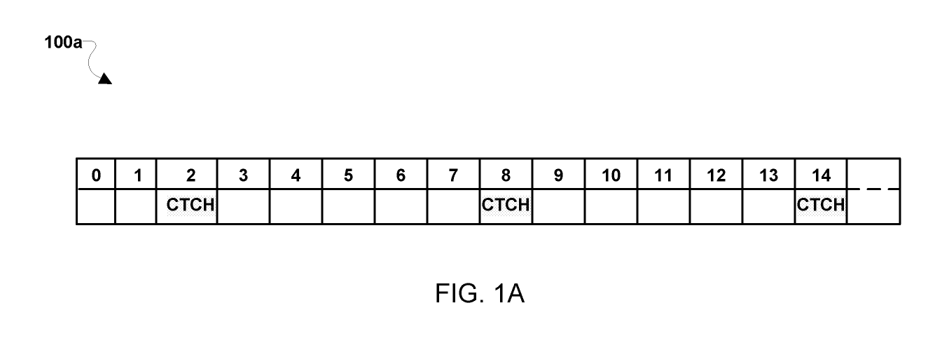

Mobile networks may transmit broadcast messages using a broadcast and multicast control (BMC) protocol layer over a common traffic channel (CTCH). The broadcast messages may be sent using discontinuous reception (DRX) over the CTCH, and may be scheduled for transmission during certain radio frames. A cell broadcast service (CBS) allows cell broadcast messages to be sent to mobile stations and may be transmitted at a defined repetition interval. The CBS Schedule message may state which fragments of CBS messages are sent at specific frames. The schedule for transmitting the broadcast messages may vary depending on various network parameters, such as the CTCH allocation period, the CTCH frame offset, and the DRX scheduling mode utilized by the network. A mobile communication device may use the random access channel to transmit Internet Protocol (IP) packets during uplink communications and the forward access channel (FACH) during downlink communications to receive IP packets. The mobile communication device may be notified of the network's DRX scheduling mode and other parameters, and then tune the RF resource to receive the broadcast messages during the correct frames. The medium access control (MAC) layer multiplexes the broadcast/multicast control (BMC) onto the FACH transport channel with the CTCH logical channel. The FACH is then multiplexed onto the secondary common control physical channel (S-CCPCH) with the paging channel (PCH) transport channel, which also uses DRX to transmit in particular frames. The actual transmission time interval (TTI) in the FACH that is utilized by the CTCH is determined by the CTCH allocation period and the CBS frame offset parameters. For example, FIG. 1A is a timing diagram 100a illustrating a CTCH transmission schedule in which the CTCH allocation period is six, the CTCH frame offset is two, and the number of radio frames in the TTI of the FACH used for the CTCH is one.

One example of a broadcast message is an emergency message. Examples of emergency messages include the Earthquake and Tsunami Warning System (ETWS) and the Commercial Mobile Alert System (CMAS) which are part of the public warning system (PWS) in the United States. For example, CMAS emergency messages may be used to notify users of presidential threats, immediate safety threats or child abduction alerts (Amber Alerts). Message identifier values within the decimal range 4370 to 4399 are used for CMAS messages. Mobile network service providers usually prioritize and deliver emergency messages to their users within a certain time frame. Emergency messages may be delivered to all mobile device users within a predetermined notification area.

Emergency messages may be delivered in two parts. The first part is the primary or initial notification. The primary notification may be used to alert mobile device users of the emergency situation and may include the most important information. Mobile network service providers may prioritize the emergency messages above all other traffic and may deliver the primary notification within a specified time frame (e.g., four seconds) to all mobile communication devices in a notification area where the emergency message is expected to be distributed even under network congestion situations.

A secondary notification may follow the primary notification and provide more detailed information about the emergency situation and possible instructions for the mobile device users to follow, for example instructions on what to do or where to get help. The secondary notification may be delivered to users in the notification area where the emergency message is expected to be distributed even under network congestion situations as long as the emergency lasts. The secondary notification may be delivered in multiple message segments, and may be repeatedly delivered within a predetermined time period. For example, a secondary notification may include three unique message segments, and each of the three unique message segments may be repeatedly delivered during the predetermined time period.

The predetermined time period for delivering the secondary notification may depend at least on the DRX level scheduling mode that is currently utilized by the mobile base stations. For example, if the mobile base station is utilizing DRX Level 1, the predetermined time period may last two minutes. If the mobile base station is utilizing DRX Level 2, the predetermined time period may last thirty minutes.

In MSMS mobile communication devices, such as a DSDS device with a first and a second subscription, when a first subscription begins receiving an emergency message, the first subscription may be given priority to use the shared RF resource for a predetermined time period (e.g., two or thirty minutes, depending on the DRX scheduling mode) to receive the primary notification and the repeated transmissions of the secondary notification. During the predetermined time period the first subscription may not be able to enter an idle mode because it continually checks for incoming emergency message segments. The DRX Level 1 reception schedule may not allow the first subscription to go to sleep and release the shared RF resource from its DRX operations because the periodicity may be as low as 10-50 milliseconds (ms). During this time period, the second subscription is denied access to the shared RF resource and thus cannot connect with its associated network. If the emergency message is continually decoded on the first subscription for 2 minutes or 30 minutes (depending on whether DRX Level 1 or Level 2 is used) because it has a higher priority, it may result in an out of service condition for the second subscription if it is unable to monitor its associated network after a certain period of time (e.g., 12 seconds). As a result, the second subscription may not be able to receive any pages or incoming calls, or make outgoing calls, even if such calls are important. After the predetermined time period expires, the second subscription will have to reacquire service with its associated network, which may take a long time. For example, after going out of service, the second subscription may not be able to reacquire service and camp on a network cell for 2 minutes or 30 minutes. After 2 minutes or 30 minutes, the second subscription may attempt to reacquire service but by this time the mobile communication device may have moved into an area with bad signal or service and again lose its connection with the network.

To overcome this problem, the various examples include methods implemented with a processor of a mobile communication device for receiving emergency messages in a manner that enables receptions of an emergency message on a first subscription while giving a second subscription sufficient time to access the shared RF resourced to maintain service. The mobile communication device may prioritize a first subscription for a predetermined time period in order to receive an emergency message. The mobile communication device may determine whether the first subscription should be de-prioritized before the predetermined time period expires based on a reception history of the first subscription during the predetermined time period, and tune the shared RF resource to the second subscription before the predetermined time period expires in response to determining that the first subscription should be de-prioritized before the predetermined time period expires.

In some examples, the reception history may be the number of unique message segments of the emergency message that the mobile communication device is able to successfully decode. For example, the mobile communication device may attempt to decode received unique message segments and for each unique message segment that is successfully decoded, increment an associated counter. The mobile communication device may determine whether the counters for each unique message segment are greater than or equal to (or exceed) a threshold, and tune the RF resource to the second subscription before the predetermined time period expires in response to determining that the counters for each unique message segment are greater than or equal to the threshold. If the counters for each unique message segment are not greater than or equal to the threshold, the mobile communication device may continue to receive additional unique message segments and increment the associated counters.

In other examples, the reception history may be the number of consecutive frames during which the first subscription does not receive any decodable blocks of message segments. For example, the mobile communication device may determine whether a message segment is received during a current frame and increment a counter in response to determining that no message segment is received during the current frame. The mobile communication device may then determine whether the counter is greater than or equal to a threshold, and tune the RF resource to the second subscription before the predetermined time period expires in response to determining that the counter is greater than or equal to the threshold. If a message segment is received during the current frame, the counter may be reset.

Various examples may be implemented within a variety of communication systems 100b, such as at least two mobile telephony networks, an example of which is illustrated in FIG. 1B. A first mobile network 102 and a second mobile network 104 typically each include a plurality of cellular base stations (e.g., a first base station 130 and a second base station 140). A first multi-SIM communication device 110 may be in communication with the first mobile network 102 through a cellular connection 132 to the first base station 130. The first multi-SIM communication device 110 may also be in communication with the second mobile network 104 through a cellular connection 142 to the second base station 140. The first base station 130 may be in communication with the first mobile network 102 over a wired connection 134. The second base station 140 may be in communication with the second mobile network 104 over a wired connection 144.

A second multi-SIM communication device 120 may similarly communicate with the first mobile network 102 through the cellular connection 132 to the first base station 130. The second multi-SIM communication device 120 may also communicate with the second mobile network 104 through the cellular connection 142 to the second base station 140. The cellular connections 132 and 142 may be made through two-way wireless communication links, such as 4G LTE, 3G, CDMA, TDMA, WCDMA, GSM, and other mobile telephony communication technologies.

While the multi-SIM communication devices 110, 120 are shown connected to the first mobile network 102 and, optionally, to the second mobile network 104, in some examples (not shown), the multi-SIM communication devices 110, 120 may include two or more subscriptions to two or more mobile networks and may connect to those subscriptions in a manner similar to those described above.

In some examples, the first multi-SIM communication device 110 may optionally establish a wireless connection 152 with a peripheral device 150 used in connection with the first multi-SIM communication device 110. For example, the first multi-SIM communication device 110 may communicate over a Bluetooth® link with a Bluetooth-enabled personal computing device (e.g., a “smart watch”). In some examples, the first multi-SIM communication device 110 may optionally establish a wireless connection 162 with a wireless access point 160, such as over a Wi-Fi connection. The wireless access point 160 may be configured to connect to the Internet 164 or another network over a wired connection 166.

While not illustrated, the second multi-SIM communication device 120 may similarly be configured to connect with the peripheral device 150 and/or the wireless access point 160 over wireless links.

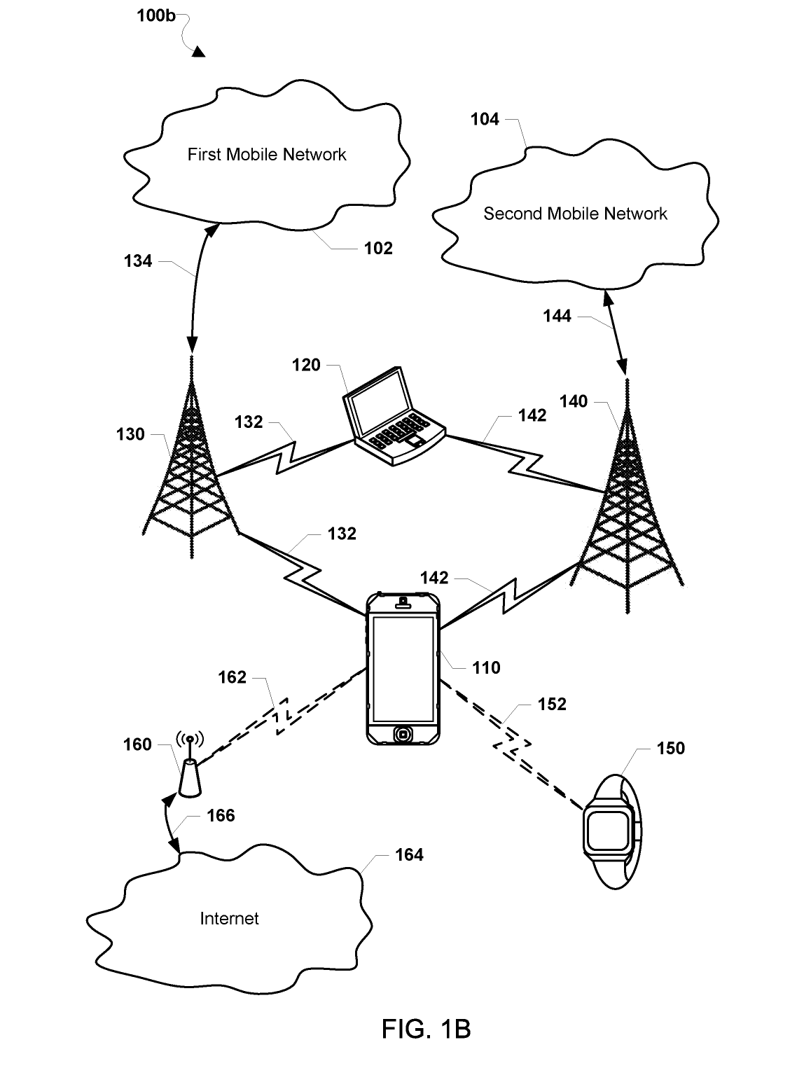

FIG. 2 is a functional block diagram of a multi-SIM communication device 200 suitable for implementing various examples. The multi-SIM communication device 200 may be similar to one or more of the multi-SIM communication devices 110, 120 as described. The multi-SIM communication device 200 may include a first SIM interface 202a, which may receive a first identity module SIM-1 204a that is associated with a first subscription. The multi-SIM communication device 200 may also optionally include a second SIM interface 202b, which may receive an optional second identity module SIM-2 204b that is associated with a second subscription.

A SIM in various examples may be a Universal Integrated Circuit Card (UICC) that is configured with SIM and/or Universal SIM applications, enabling access to, for example, GSM and/or UMTS networks. The UICC may also provide storage for a phone book and other applications. Alternatively, in a CDMA network, a SIM may be a UICC removable user identity module (R-UIM) or a CDMA subscriber identity module (CSIM) on a card. A SIM card may have a CPU, ROM, RAM, EEPROM and I/O circuits.

A SIM used in various examples may contain user account information, an international mobile subscriber identity (IMSI), a set of SIM application toolkit (SAT) commands, and storage space for phone book contacts. A SIM card may further store home identifiers (e.g., a System Identification Number (SID)/Network Identification Number (NID) pair, a Home PLMN (HPLMN) code, etc.) to indicate the SIM card network operator provider. An Integrated Circuit Card Identity (ICCID) SIM serial number may be printed on the SIM card for identification. However, a SIM may be implemented within a portion of memory of the multi-SIM communication device 200 (e.g., in a memory 214), and thus need not be a separate or removable circuit, chip or card.

The multi-SIM communication device 200 may include at least one controller, such as a general processor 206, which may be coupled to a coder/decoder (CODEC) 208. The CODEC 208 may in turn be coupled to a speaker 210 and a microphone 212. The general processor 206 may also be coupled to the memory 214. The memory 214 may be a non-transitory computer-readable storage medium that stores processor-executable instructions. For example, the instructions may include routing communication data relating to the first or second subscription though a corresponding baseband-RF resource. The memory 214 may store an operating system (OS), as well as user application software and executable instructions.

The general processor 206 and the memory 214 may each be coupled to at least one baseband modem processor 216. Each SIM and/or RAT in the multi-SIM communication device 200 (e.g., the SIM-1 204a and/or the SIM-2 204b) may be associated with a baseband-RF resource. A baseband-RF resource may include the baseband modem processor 216, which may perform baseband/modem functions for communications with/controlling a RAT, and may include one or more amplifiers and radios, referred to generally herein as RF resources (e.g., RF resource 218). In some examples, baseband-RF resources may share the baseband modem processor 216 (i.e., a single device that performs baseband/modem functions for all RATs on the multi-SIM communication device 200). In other examples, each baseband-RF resource may include physically or logically separate baseband processors (e.g., BB1, BB2).

The RF resource 218 may be a transceiver that performs transmit/receive functions for each of the SIMs/RATs on the multi-SIM communication device 200. The RF resource 218 may include separate transmit and receive circuitry, or may include a transceiver that combines transmitter and receiver functions. In some examples, the RF resource 218 may include multiple receive circuits. The RF resource 218 may be coupled to a wireless antenna (e.g., a wireless antenna 220). The RF resource 218 may also be coupled to the baseband modem processor 216.

In some examples, the general processor 206, the memory 214, the baseband processor(s) 216, and the RF resource 218 may be included in the multi-SIM communication device 200 as a system-on-chip 250. In some examples, the first and second SIMs 204a, 204b and their corresponding interfaces 202a, 202b may be external to the system-on-chip 250. Further, various input and output devices may be coupled to components on the system-on-chip 250, such as interfaces or controllers. Example user input components suitable for use in the multi-SIM communication device 200 may include, but are not limited to, a keypad 224, a touchscreen display 226, and the microphone 212.

In some examples, the keypad 224, the touchscreen display 226, the microphone 212, or a combination thereof, may perform the function of receiving a request to initiate an outgoing call. For example, the touchscreen display 226 may receive a selection of a contact from a contact list or receive a telephone number. In another example, either or both of the touchscreen display 226 and the microphone 212 may perform the function of receiving a request to initiate an outgoing call. For example, the touchscreen display 226 may receive a user selection of a contact from a contact list or receive a telephone number. As another example, the request to initiate the outgoing call may be in the form of a voice command received via the microphone 212. Interfaces may be provided between the various software modules and functions in the multi-SIM communication device 200 to enable communication between them, as is known in the art.

Functioning together, the two SIMs 204a, 204b, the baseband processor BB1, BB2, the RF resource 218, and the wireless antenna 220 may constitute two or more radio access technologies (RATs). For example, the multi-SIM communication device 200 may be a communication device that includes a SIM, baseband processor, and RF resource configured to support two different RATs, such as LTE and GSM. More RATs may be supported on the multi-SIM communication device 200 by adding more SIM cards, SIM interfaces, RF resources, and antennae for connecting to additional mobile networks.

In some examples (not shown), the multi-SIM communication device 200 may include, among other things, additional SIM cards, SIM interfaces, a plurality of RF resources associated with the additional SIM cards, and additional antennae for supporting subscriptions communications with additional mobile networks.

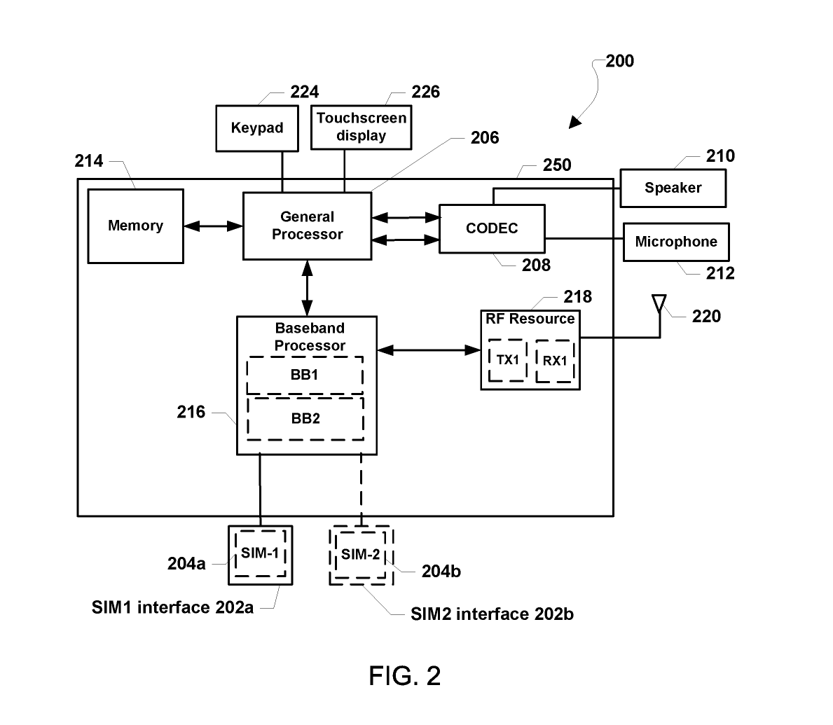

FIG. 3 illustrates an example timing diagram 300 of conventional reception scheduling for an emergency message on a mobile communication device. The timing diagram 300 shows the reception schedule for a first subscription 302 and a second subscription 304 of a MSMS mobile communication device.

In the illustrated example, the first subscription 302 receives a primary emergency message notification at radio frame 306. The emergency message may be, for example, an ETWS or CMAS emergency message broadcast by a network associated with the first subscription 302.

In response to the primary emergency message notification, the mobile communication device may prioritize reception by the first subscription 302 for a predetermined time period 308. The predetermined time period 308 may be based on the DRX scheduling mode utilized by the network associated with the first subscription 302. For example, the predetermined time period 308 may last for two minutes under DRX Level 1, and thirty minutes under DRX Level 2.

During the predetermined time period 308, the first subscription 302 may receive repeated transmissions of the secondary notification of the emergency message. The secondary notification may be broken into multiple unique message segments. For example, the secondary notification may have two unique message segments that are repeatedly transmitted. As illustrated in the timing diagram 300, a first unique message segment may be transmitted every four radio frames 310a-310d, and a second unique message segment may be transmitted every four radio frames 312a-312d interspersed with the first unique message segment transmissions. Thus, each unique message segment of the secondary notification may be transmitted four times during the predetermined time period 308. The number of unique message segments, the number of times each unique message segment is repeatedly transmitted, and the transmission schedule of the message segments may vary from the example shown in the timing diagram 300. Repeated transmissions of the message segments increases the likelihood that mobile devices will receive and decode the complete message.

During the predetermined time period 308, the second subscription 304 does not have control of the shared RF resource because the first subscription 302 has priority. During the predetermined time period 308, the network associated with the second subscription 304 may transmit one or more paging notifications during radio frames 314a, 314b as well as other messages to the second subscription 304. The second subscription 304 is not able to receive those paging notifications or other messages from the network (represented by cross-hatching), and may eventually go out of service. A user may also not be able to initiate outgoing calls using the second subscription 304 during the predetermined time period 308. After the predetermined time period 308 expires, the second subscription 304 may have to reestablish a service connection with its associated network.

The various examples disclosed herein may overcome this problem by de-prioritizing the first subscription before the predetermined time period expires based on the reception history of the first subscription. Because the message segments of the secondary notification are repeatedly transmitted, once the mobile communication device has successfully received and decoded each message segment, the first subscription can be de-prioritized without missing any of the emergency message. In other words, there is no need to continue receiving the same repeated message segments once the full message has been decoded. Alternatively, the mobile communication device may determine whether the first subscription has not received any decodable message segments for a certain number of consecutive frames. This may indicate that the network has completed transmissions of the repeated message segments before the predetermined time period expired; in which case the first subscription may be de-prioritized.

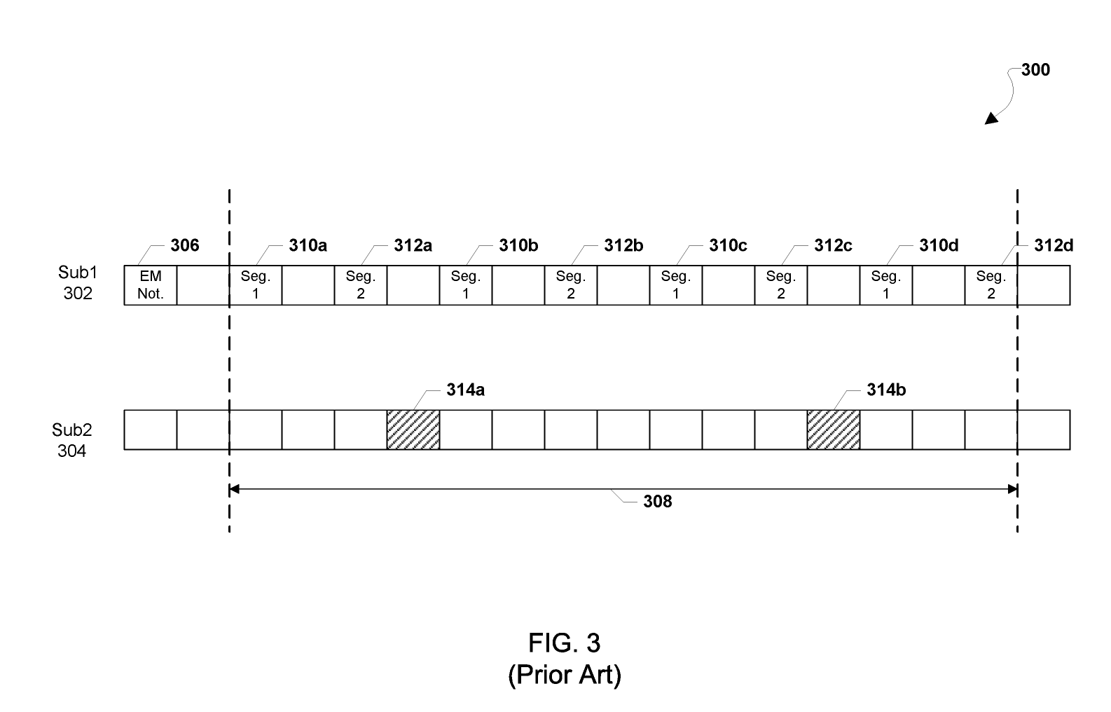

FIG. 4 illustrates an example timing diagram 400 of adaptive reception of an emergency message on a mobile communication device according to various examples. The timing diagram 400 shows the reception schedule for a first subscription 402 and a second subscription 404 of a MSMS mobile communication device.

In the illustrated example, the first subscription 402 receives a primary emergency message notification at radio frame 406. The emergency message may be, for example, an ETWS or CMAS emergency message broadcast by a network associated with the first subscription 402.

In response to the primary emergency message notification, the mobile communication device may prioritize reception by the first subscription 402 for a predetermined time period 408. The predetermined time period 408 may be based on the DRX scheduling mode utilized by the network associated with the first subscription 402. For example, the predetermined time period 408 may last for two minutes under DRX Level 1, and thirty minutes under DRX Level 2.

During the predetermined time period 408, the first subscription 402 may receive repeated transmissions of the secondary notification of the emergency message. The secondary notification may be broken into multiple unique message segments. For example, the secondary notification may have two unique message segments that are repeatedly transmitted, denoted as Seg. 1 and Seg. 2 in FIG. 4. Each unique message segment may be associated with a message identification number or value. Typically, networks repeat the emergency messages sent through ETWS or CMAS. As discussed above and illustrated in the timing diagram 400, a first unique message segment may be transmitted every four radio frames 410a-410d, and a second unique message segment may be transmitted every four radio frames 412a-412d. The number of unique message segments, the number of times each unique message segment is repeatedly transmitted, and the transmission schedule of the message segments may vary from the example shown in the timing diagram 400. Once the mobile communication device detects reception of an emergency message on the first subscription 402, the mobile communication device may prioritize the activities of the first subscription 402 over the second subscription 404.

The mobile communication device may also create one or more buffer arrays or counters, and maintain the counters with the number of times the first subscription 402 receives each unique message segment. For example, the mobile communication device may associate a counter with each unique message segment. For example, a counter may be associated with the first unique message segment, and another counter may be associated with the second unique message segment. The counters may initially be set to zero. Each time the first subscription 402 receives and successfully decodes a unique message segment, the mobile communication device may increment the associated counter.

For example, after receiving and decoding the first unique message segment in the radio frame 410a, the mobile communication device may increment the counter associated with the first unique message segment by one. After receiving and decoding the second unique message segment in the radio frame 412a, the mobile communication device may increment the counter associated with the second unique message segment by one. After receiving and decoding the first unique message segment again in the radio frame 410b, the mobile communication device may increment the associated counter so that it equals two. After receiving and decoding the second unique message segment again in the radio frame 412b, the mobile communication device may increment the associated counter so that it equals two as well.

Periodically or after receiving each unique message segment, the mobile communication device may compare each counter to a threshold. The threshold may represent the number of successful decodes of unique message segments that indicates the whole emergency message has been successfully received and decoded. For example, after receiving and successfully decoding the unique message segments in the radio frames 410a, 410b, 412a, and 412b, the mobile communication device may compare the counter associated with each unique message segment with a threshold (e.g., two). Once the counter(s) reach the threshold, the priority for the first subscription 402 may be reduced. For example, if both counters are greater than or equal to the threshold, the mobile communication device may de-prioritize the first subscription 402 and tune the shared RF resource to the second subscription 404. If at least one counter is not greater than or equal to the threshold, the mobile communication device may continue to prioritize the first subscription 402 until it has received and decoded the threshold number of each unique message segment, or until the predetermined time period 408 expires.

As illustrated in the timing diagram 400 with the threshold equal to two, after receiving and successfully decoding the unique message segments in the radio frames 410a, 410b, 412a, and 412b, the mobile communication device may de-prioritize the first subscription 402 at a time 416 after receiving and decoding the message segment in the radio frame 412b. The network associated with the second subscription 404 may transmit paging notifications during the radio frames 414a and 414b. In the illustrated example, the radio frame 414a occurs when the first subscription 402 has priority, and so the second subscription 404 may not receive the paging notification at the radio frame 414a (indicated by cross hatching). However, the radio frame 414b occurs after the time 416 when the second subscription 404 may utilize the RF resource. Thus, the second subscription 404 may receive the paging notification in the radio frame 414b. Conversely, the first subscription 402 may not receive the additional repeated transmissions of the unique message segments in the radio frames 410c, 412c, 410d, and 412d (indicated by cross hatching).

In some examples, after de-prioritizing the first subscription 402 at the time point 416, the second subscription 404 may have priority over the RF resource for the remainder of the predetermined time period 408. In other examples, the second subscription 404 may have priority for certain times during the remainder of the predetermined time period 408. For example, the second subscription 404 may be given priority during time periods when the second subscription 404 is expecting to receive paging notifications or other messages, but the first subscription 402 may be given priority at all other times for the remainder of the predetermined time period 408. A user may also make outgoing calls using the second subscription 404 when it has priority over the RF resource. Generally, there may be a number of different ways that the first subscription 402 and the second subscription 404 may share the RF resource after the time point 416 and before the predetermined time period 408 expires.

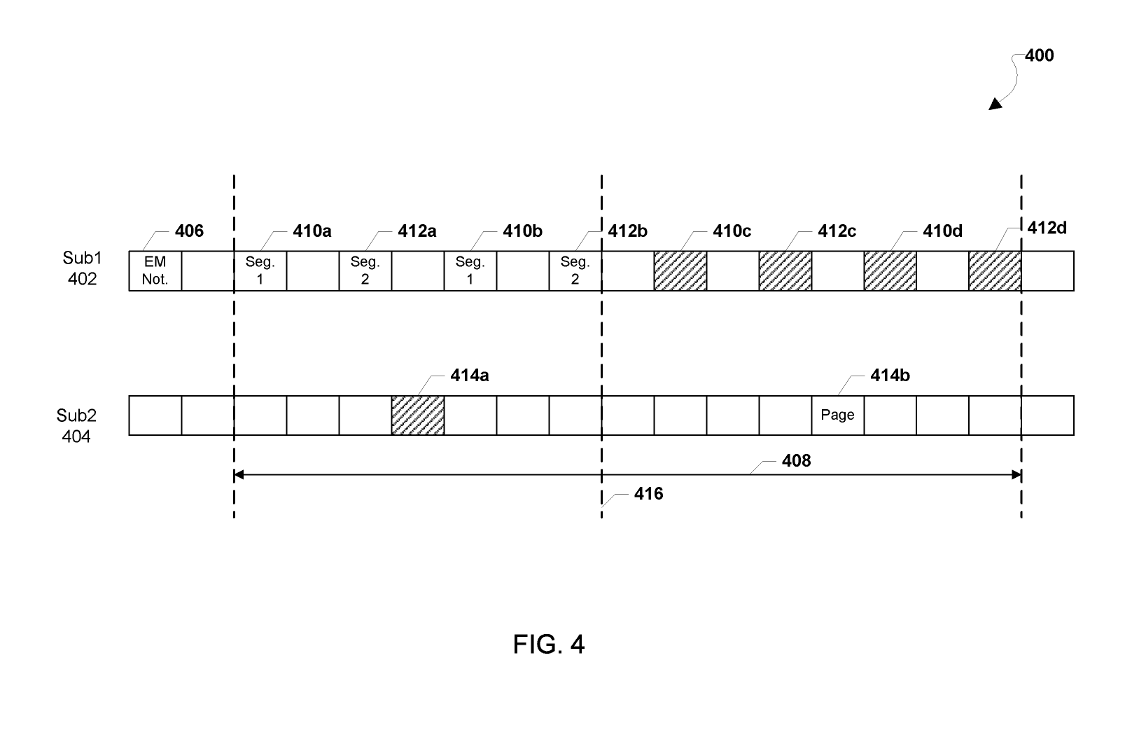

FIG. 5 illustrates another example timing diagram 500 of adaptive reception of an emergency message on a mobile communication device according to various examples. The timing diagram 500 shows the reception schedule for a first subscription 502 and a second subscription 504 of a MSMS mobile communication device. In the example illustrated in FIG. 5, the first subscription 502 receives a primary emergency message notification at radio frame 506. The emergency message may be, for example, an ETWS or CMAS emergency message broadcast by a network associated with the first subscription 502. In response to the primary emergency message notification, the mobile communication device may prioritize reception by the first subscription 502 for a predetermined time period 508. The predetermined time period 508 may be based on the DRX scheduling mode utilized by the network associated with the first subscription 502. For example, the predetermined time period 508 may last for two minutes under DRX Level 1, and thirty minutes under DRX Level 2.

During the predetermined time period 508, the first subscription 502 may receive repeated transmissions of the secondary notification of the emergency message. The secondary notification may be broken into multiple unique message segments. For example, the secondary notification may have two unique message segments that are repeatedly transmitted. As illustrated in the timing diagram 500, a first unique message segment may be transmitted in radio frames 510a and 510b, and a second unique message segment may be transmitted in radio frames 512a and 512b. Thus each unique message segment of the secondary notification may be transmitted every four radio frames during the predetermined time period 508. The number of unique message segments, the number of times each unique message segment is repeatedly transmitted, and the transmission schedule of the message segments may vary from the example shown in the timing diagram 500.

In DSDS mobile communication devices, the physical layer of the modem may keep track of continuous no block received instances for emergency messages using a counter, and inform the non-access stratum (NAS) module of the RF resource when the counter reaches a threshold. This may allow the NAS module to take action and reduce priorities of the activities on the CTCH. For example, the physical layer of the modem in the mobile communication device may initiate a counter when the predetermined time period 508 begins. This counter may count the number of consecutive radio frames during which the first subscription 402 does not receive any decodable message segments. The counter may be compared to a threshold. If the counter is greater than or equal to the threshold, the first subscription 402 may be de-prioritized. For example, the NAS module in the RF resource may de-prioritize broadcast messages from the CTCH. The threshold may represent a threshold duration (measured in radio frames) that indicates that the network is no longer broadcasting emergency message segments.

For example as illustrated in the timing diagram 500, the threshold may be equal to four. The counter may be initiated to zero after receiving the primary emergency notification in the radio frame 506. The counter may be incremented for each consecutive radio frame in which no decodable message segment is received. If a decodable message segment is received, the counter may be reset to zero. Thus, the counter may be reset at the radio frames 510a, 512a, 510b, and 512b when the network transmits the first or second unique message segments. However, after the radio frame 512b the network may stop transmitting emergency message segments. The counter may be incremented at each radio frame after the radio frame 512b. When the counter reaches the threshold (which is four in this example) at time 516, the mobile communication device may de-prioritize the first subscription 502 and tune the shared RF resource to the second subscription 504.

The network associated with the second subscription 504 may transmit paging notifications during radio frames 514a and 514b. The radio frame 514a occurs when the first subscription 502 has priority, and so the second subscription 504 may not receive the paging notification at the radio frame 514a (indicated by cross hatching). However, the radio frame 514b occurs after the time 516, when the second subscription 504 may utilize the RF resource. Thus, the second subscription 504 may receive the paging notification in the radio frame 514b.

In some examples, after de-prioritizing the first subscription 502 at the time point 516, the second subscription 504 may have priority over the RF resource for the remainder of the predetermined time period 508. In other examples, the second subscription 504 may have priority for certain times during the remainder of the predetermined time period 508. For example, the second subscription 504 may be given priority during time periods when it is expecting to receive paging notifications or other messages, but the first subscription 502 may be given priority at all other times for the remainder of the predetermined time period 508. A user may also make outgoing calls using the second subscription 504 when it has priority over the RF resource. Generally, there may be a number of different ways that the first subscription 502 and the second subscription 504 may share the RF resource after the time point 516 and before the predetermined time period 508 expires.

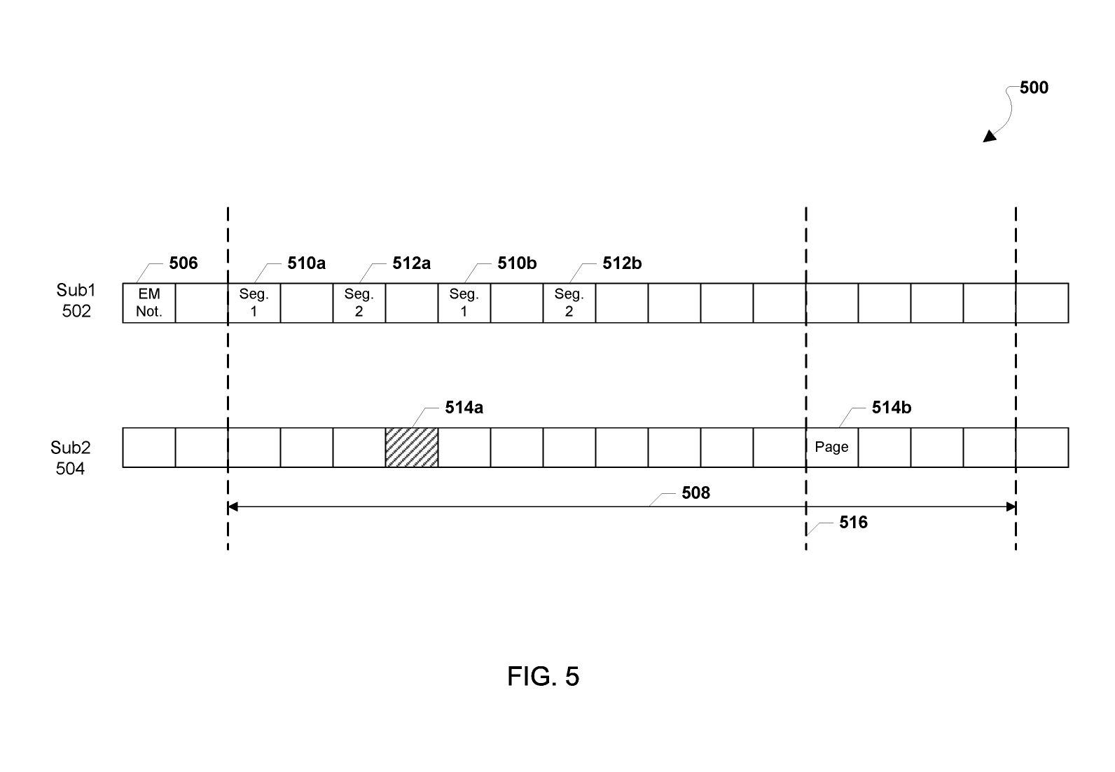

FIG. 6 illustrates a method 600 for receiving emergency messages on a mobile communication device according to various examples. The method 600 may be implemented in a processor (e.g., the general processor 206, the baseband modem processor 216, a separate controller, and/or the like) of a mobile communication device (such as the multi-SIM communication devices 110, 120, and 200). The mobile communication device may have one RF resource that is shared by a first subscription and a second subscription (e.g., a MSMS communication device). For purposes of describing the method 600, the first subscription receives the emergency notification and thus has priority over the second subscription for using the RF resource to receive the emergency message; however, the reference to “first” and “second” subscriptions is arbitrary as either subscription may receive the emergency message.

In block 602, the processor may receive a primary notification of an emergency message on the first subscription, which may be received through a CTCH. The primary notification may notify the mobile communication device of important emergency information.

In block 604, the processor may prioritize the first subscription for a predetermined time period to receive the emergency message, specifically, the repeated transmissions of the one or more unique message segments of the secondary notification that follows the primary notification. The secondary notification may include repeated transmissions of one or more unique message segments. For example, the secondary emergency notification may include three unique message segments, each of which may be repeatedly broadcast by the network. Thus, the predetermined time period may be long enough to receive the repeated transmissions of the secondary message segments, and may be based on the DRX scheduling mode utilized by the network associated with the first subscription. For example, the predetermined time period may last for two minutes under DRX Level 1, and thirty minutes under DRX Level 2.

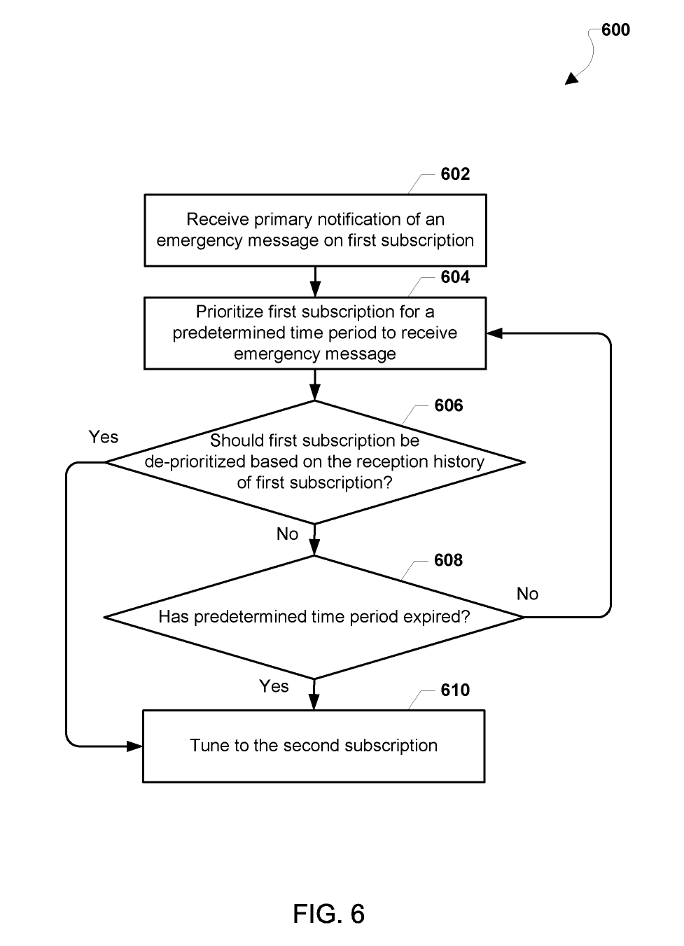

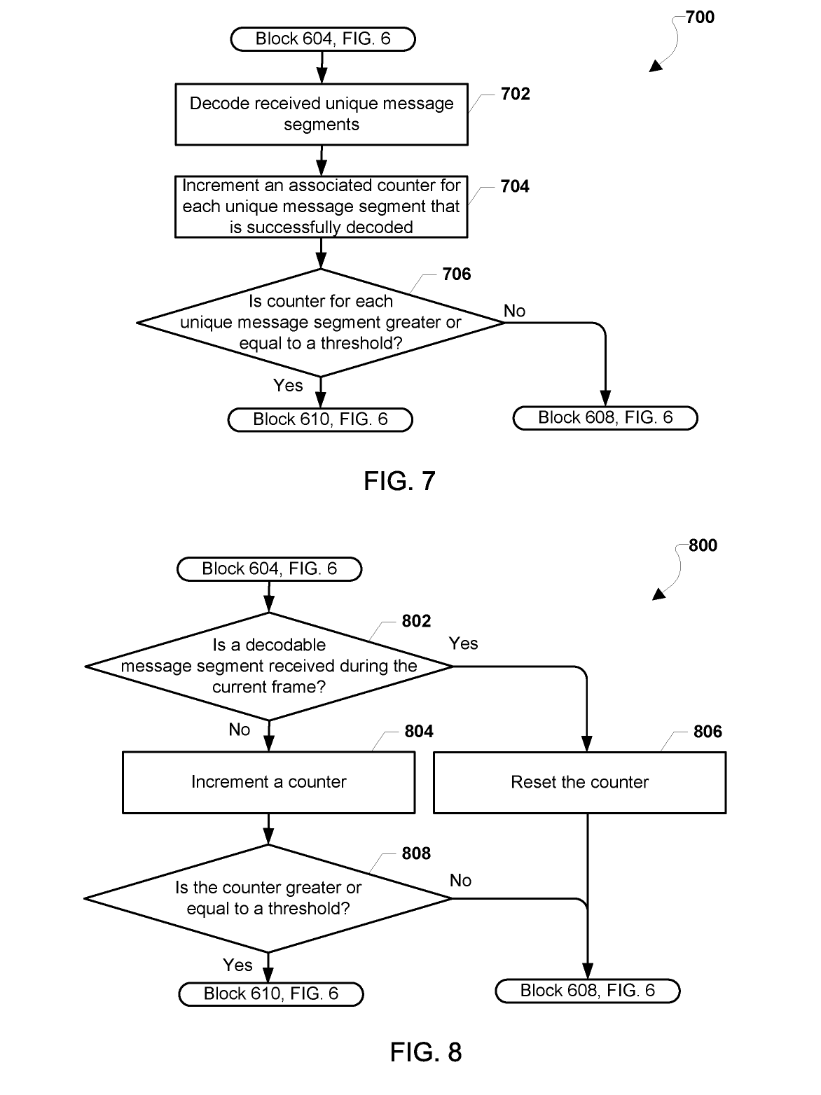

In determination block 606, the processor may determine whether the first subscription should be de-prioritized before the predetermined time period expires based on the reception history of the first subscription during the predetermined time period. In some examples, the reception history may include whether the first subscription has received a threshold number of each unique message segment of the emergency message. In other examples, the reception history may include determining whether there have been a threshold number of consecutive radio frames during which no decodable message segment blocks are received. Further details regarding determining the reception history of the first subscription during the predetermined time period are described with reference to FIGS. 7-8.

In response to determining that the first subscription should not be de-prioritized before the predetermined time period expires (i.e., determination block 606=“No”), the processor may determine whether the predetermined time period has expired in determination block 608. In response to determining that the predetermined time period has not expired (i.e., determination block 608=“No”), the processor may continue to prioritize the first subscription during the predetermined time period in block 604.

In response to determining that the predetermined time period has expired (i.e., determination block 608=“Yes”), or in response to determining that the first subscription should be de-prioritized before the predetermined time period expires (i.e., determination block 606=“Yes”), the processor may tune the RF resource to the second subscription in block 610. In cases in which the first subscription is de-prioritized before the predetermined time period expires, the processor may tune the RF resource to the second subscription for the remainder of the predetermined time period. Alternatively, the processor may balance the priorities of the first and second subscriptions for accessing the RF resource based on normal (i.e., non-emergency) reception conditions. In this manner, the method 600 provides a way to dynamically balance the priorities of subscriptions on a mobile communication device while receiving an emergency message on one subscription.

FIG. 7 illustrates a method 700 for determining whether a first subscription receiving an emergency message should be de-prioritized before the predetermined time period expires according to various examples. The method 700 may be implemented with a processor (e.g., the general processor 206, the baseband modem processor 216, a separate controller, and/or the like) of a mobile communication device (such as the multi-SIM communication devices 110, 120, and 200). The mobile communication device may have one RF resource that is shared by a first subscription and a second subscription (e.g., a MSMS communication device). For purposes of describing the method 700, the first subscription is receiving the emergency notification and thus has priority over the second subscription for using the RF resource to receive the emergency message; however, the reference to “first” and “second” subscriptions is arbitrary as either subscription may receive the emergency message.

The method 700 may implement the operations represented by determination block 606 to determine whether the first subscription should be de-prioritized before the predetermined time period expires based on the reception history of the first subscription during the predetermined time period.

After the processor prioritizes the first subscription for a predetermined time period to receive the emergency message in block 604, the processor may decode each received unique message segment in block 702. The emergency message may include one or more unique message segments, and the network may repeatedly transmit the one or more unique message segments during the predetermined time period. Due to varying radio conditions, the first subscription may not be able to receive and/or decode the transmitted message segments.

In block 704, the processor may increment a counter for each unique message segment that is successfully decoded. Each unique message segment may be associated with a counter. For example, if an emergency message includes three unique message segments, the processor may maintain three counters, one for each unique message segment. Whenever the first subscription successfully receives and decodes a unique message segment, the associated counter may be incremented. If the received message segment is not received and/or decoded, the counter is not incremented.

In determination block 706, the processor may determine whether the counters for the unique message segments are each greater than or equal to a threshold. The threshold may represent the number of successful decodes of unique message segments that indicates that the whole emergency message has been successfully received and decoded.

In response to determining that the counters for the unique message segments are each greater than or equal to the threshold (i.e., determination block 706=“Yes”), the processor may tune the RF resource to the second subscription before the predetermined time period expires in block 610 of the method 600 as described with reference to FIG. 6. In other words, when the first subscription has received each unique message segment at least a threshold number of times to be assured of full reception, the first subscription may be de-prioritized. For example, if there are three unique message segments and three counters, each counter may be compared to the threshold. If all three counters are greater than or equal to the threshold, the first subscription may be de-prioritized.

In response to determining that the counters for the unique message segments are not each greater than or equal to the threshold (i.e., determination block 706=“No”), the processor may determine whether the predetermined time period has expired in determination block 608 of the method 600 as described with reference to FIG. 6. In other words, when the first subscription has not received each unique message segment at least a threshold number of times, the first subscription may continue to be prioritized if the predetermined time period has not expired yet. For example, if there are three unique message segments and three counters, each counter may be compared to the threshold. If at least one counter is less than the threshold, the first subscription may continue to be prioritized. In this manner, the method 700 utilizes unique message segment counters to dynamically determine whether a subscription receiving an emergency message may be de-prioritized early.

FIG. 8 illustrates another method 800 for determining whether a first subscription receiving an emergency message should be de-prioritized before a predetermined time period expires according to various examples. The method 800 may be implemented with a processor (e.g., the general processor 206, the baseband modem processor 216, a separate controller, and/or the like) of a mobile communication device (such as the multi-SIM communication devices 110, 120, and 200). The mobile communication device may have one RF resource that is shared by a first subscription and a second subscription (e.g., a MSMS communication device). For purposes of describing the method 800, the first subscription is receiving the emergency notification and thus has priority over the second subscription for using the RF resource to receive the emergency message; however, the reference to “first” and “second” subscriptions is arbitrary as either subscription may receive the emergency message.

The method 800 may implement the operations represented by determination block 606 to determine whether the first subscription should be de-prioritized before the predetermined time period expires based on the reception history of the first subscription during the predetermined time period.

After the processor prioritizes the first subscription for a predetermined time period to receive the emergency message in block 604, the processor may determine whether a decodable message segment is received during the current frame in determination block 802. The emergency message may include one or more unique message segments, and the network may schedule transmission of the message segments during certain radio frames. For example, the network may transmit a message segment during every third radio frame. A counter may be initiated and set to zero by the physical layer of the RF resource in the mobile communication device. This counter may count the number of consecutive frames during which no decodable message segments are received.

In response to determining that a decodable message segment has been received during the current frame (i.e., determination block 802=“Yes”), the processor may reset the counter to zero in block 806, and determine whether the predetermined time period has expired in determination block 608 of the method 600 as described with reference to FIG. 6. In other words, when the first subscription has received an emergency message segment during the current frame, the first subscription may continue to be prioritized so long as the predetermined time period has not expired.

In response to determining that no decodable message segment has been received during the current frame (i.e., determination block 802=“No”), the processor may increment the counter in block 804.

In determination block 808, the processor may then determine whether the counter is greater than or equal to a threshold. This determination may be made periodically and/or after incrementing the counter. The threshold may represent a threshold duration (measured in radio frames) that indicates that the network may no longer be broadcasting emergency message segments.

In response to determining that the counter is greater than or equal to the threshold (i.e., determination block 808=“Yes”), the processor may tune to the second subscription before the predetermined time period expires in block 610 of the method 600 as described with reference to FIG. 6. In other words, when the first subscription has not received any decodable message segments for a threshold number of consecutive frames, the first subscription may be de-prioritized.

In response to determining that the counter is not greater than or equal to the threshold (i.e., determination block 808=“No”), the processor may determine whether the predetermined time period has expired in determination block 608 of the method 600 as described with reference to FIG. 6. In other words, when the first subscription has not received any decodable message segments for a number of consecutive frames that is less than the threshold, the first subscription may continue to be prioritized if the predetermined time period has not expired yet. In this manner, the method 800 utilizes a frame counter to dynamically determine whether a subscription receiving an emergency message may be de-prioritized early.

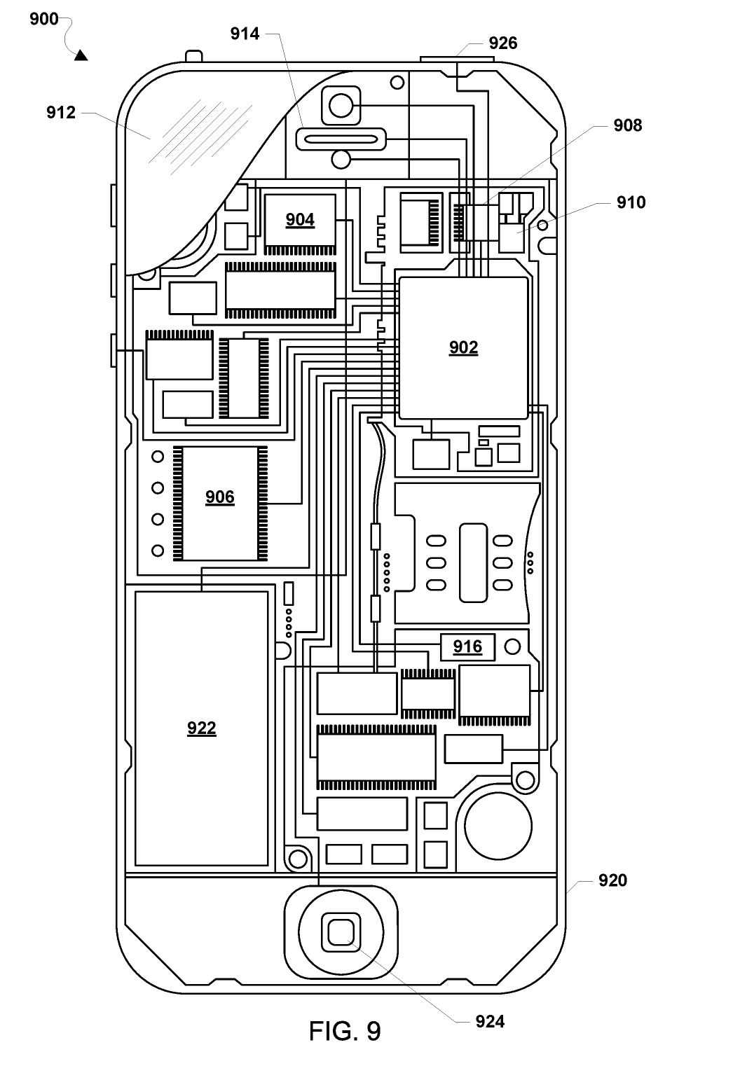

Various examples may be implemented in any of a variety of multi-SIM communication devices, an example of which (e.g., multi-SIM communication device 900) is illustrated in FIG. 9. The multi-SIM communication device 900 may be similar to the multi-SIM communication devices 110, 120, 200 and may implement the methods 600, 700, and 800.

The multi-SIM communication device 900 may include a processor 902 coupled to a touchscreen controller 904 and an internal memory 906. The processor 902 may be one or more multi-core integrated circuits designated for general or specific processing tasks. The internal memory 906 may be volatile or non-volatile memory, and may also be secure and/or encrypted memory, or unsecure and/or unencrypted memory, or any combination thereof. The touchscreen controller 904 and the processor 902 may also be coupled to a touchscreen panel 912, such as a resistive-sensing touchscreen, capacitive-sensing touchscreen, infrared sensing touchscreen, etc. Additionally, the display of the multi-SIM communication device 900 need not have touch screen capability.

The multi-SIM communication device 900 may have one or more cellular network transceivers 908 coupled to the processor 902 and to one or more antennas 910 and configured for sending and receiving cellular communications. The one or more transceivers 908 and the one or more antennas 910 may be used with the above-mentioned circuitry to implement various example methods. The multi-SIM communication device 900 may include one or more SIM cards 916 coupled to the one or more transceivers 908 and/or the processor 902 and may be configured as described above.

The multi-SIM communication device 900 may also include speakers 914 for providing audio outputs. The multi-SIM communication device 900 may also include a housing 920, constructed of a plastic, metal, or a combination of materials, for containing all or some of the components discussed herein. The multi-SIM communication device 900 may include a power source 922 coupled to the processor 902, such as a disposable or rechargeable battery. The rechargeable battery may also be coupled to the peripheral device connection port to receive a charging current from a source external to the multi-SIM communication device 900. The multi-SIM communication device 900 may also include a physical button 924 for receiving user inputs. The multi-SIM communication device 900 may also include a power button 926 for turning the multi-SIM communication device 900 on and off.

The foregoing method descriptions and the process flow diagrams are provided merely as illustrative examples and are not intended to require or imply that the steps of various examples are performed in the order presented. As will be appreciated by one of skill in the art the order of steps in the foregoing examples may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the examples disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present examples.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more aspects, the functions described may be implemented in hardware, software, firmware, or any combination thereof. If implemented in software, the functions may be stored as one or more instructions or code on a non-transitory computer-readable storage medium or non-transitory processor-readable storage medium. The steps of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed examples is provided to enable any person skilled in the art to make or use the present examples. Various modifications to these examples will be readily apparent to those skilled in the art, and the generic principles defined herein may be applied to some examples without departing from the spirit or scope of the written description. Thus, the present disclosure is not intended to be limited to the examples shown herein but is to be accorded the widest scope consistent with the following claims and the principles and novel features disclosed herein.

What is claimed is:

1. A method for receiving emergency messages on a mobile communication device having a first subscription and a second subscription sharing a radio frequency (RF) resource, comprising:
prioritizing, by a processor of the mobile communication device, the first subscription for a predetermined time period in order to receive an emergency message;
determining, by the processor, whether the first subscription should be de-prioritized before the predetermined time period expires based on a reception history of the first subscription during the predetermined time period; and
tuning the RF resource to the second subscription before the predetermined time period expires in response to determining that the first subscription should be de-prioritized before the predetermined time period expires.

2. The method of claim 1, wherein the emergency message comprises an Earthquake and Tsunami Warning System (ETWS) message or a Commercial Mobile Alert System (CMAS) message.

3. The method of claim 1,
wherein the emergency message comprises repeated transmissions of one or more message segments, and
wherein determining whether the first subscription should be de-prioritized before the predetermined time period expires based on the reception history of the first subscription during the predetermined time period comprises:
decoding, by the processor, each received message segment;
incrementing, by the processor, an associated counter by the processor for each message segment that is successfully decoded;
determining, by the processor, whether counters associated with each message segment are each greater than or equal to a threshold; and
tuning the RF resource to the second subscription before the predetermined time period expires in response to determining that the counters associated with each message segment are all greater than or equal to the threshold.

4. The method of claim 3, further comprising receiving additional repeated transmissions of the one or more message segments in response to determining that the counters associated with each message segment are not each greater than or equal to the threshold.

5. The method of claim 1,
wherein the emergency message comprises one or more message segments, and
wherein determining whether the first subscription should be de-prioritized before the predetermined time period expires based on the reception history of the first subscription during the predetermined time period comprises:
determining, by the processor, whether a decodable message segment is received during a current frame;
incrementing, by the processor, a counter in response to determining that no decodable message segment is received during the current frame;
determining, by the processor, whether the counter is greater than or equal to a threshold; and
tuning the RF resource to the second subscription before the predetermined time period expires in response to determining that the counter is greater than or equal to the threshold.

6. The method of claim 5, further comprising resetting, by the processor, the counter in response to determining that a decodable message segment is received during the current frame.

7. The method of claim 5, wherein the counter is maintained by a physical layer of the RF resource.

8. The method of claim 1, wherein the predetermined time period is based on a discontinuous reception scheduling mode of a network associated with the first subscription.

9. A mobile communication device comprising:
a memory;
a radio frequency (RF) resource; and
a processor coupled to the memory and the RF resource, configured to connect to a first subscriber identity module (SIM) associated with a first subscription and a second SIM associated with a second subscription, and configured to:
prioritize the first subscription for a predetermined time period in order to receive an emergency message;
determine whether the first subscription should be de-prioritized before the predetermined time period expires based on a reception history of the first subscription during the predetermined time period; and
tune the RF resource to the second subscription before the predetermined time period expires in response to determining that the first subscription should be de-prioritized before the predetermined time period expires.

10. The mobile communication device of claim 9, wherein the emergency message comprises an Earthquake and Tsunami Warning System (ETWS) message or a Commercial Mobile Alert System (CMAS) message.

11. The mobile communication device of claim 9,
wherein the emergency message comprises repeated transmissions of one or more message segments, and
wherein the processor is further configured to determine whether the first subscription should be de-prioritized before the predetermined time period expires based on the reception history of the first subscription during the predetermined time period by:
decoding each received message segment;
incrementing an associated counter by the processor for each message segment that is successfully decoded;
determining whether counters associated with each message segment are each greater than or equal to a threshold; and
tuning the RF resource to the second subscription before the predetermined time period expires in response to determining that the counters associated with each message segment are all greater than or equal to the threshold.

12. The mobile communication device of claim 11, wherein the processor is further configured to receive additional repeated transmissions of the one or more unique message segments in response to determining that the counters associated with each message segment are not each greater than or equal to the threshold.

13. The mobile communication device of claim 9,
wherein the emergency message comprises one or more message segments, and
wherein the processor is further configured to determine whether the first subscription should be de-prioritized before the predetermined time period expires based on the reception history of the first subscription during the predetermined time period by:
determining whether a decodable message segment is received during a current frame;
incrementing a counter in response to determining that no decodable message segment is received during the current frame;
determining whether the counter is greater than or equal to a threshold; and
tuning the RF resource to the second subscription before the predetermined time period expires in response to determining that the counter is greater than or equal to the threshold.

14. The mobile communication device of claim 13, wherein the processor is further configured to reset the counter in response to determining that a decodable message segment is received during the current frame.

15. The mobile communication device of claim 13, wherein the counter is maintained by a physical layer of the RF resource.

16. The mobile communication device of claim 9, wherein the predetermined time period is based on a discontinuous reception scheduling mode of a network associated with the first subscription.

17. A non-transitory processor-readable storage medium having stored thereon processor-executable software instructions configured to cause a processor of a mobile communication device to perform operations comprising:
prioritizing a first subscription of the mobile communication device for a predetermined time period in order to receive an emergency message;
determining whether the first subscription should be de-prioritized before the predetermined time period expires based on a reception history of the first subscription during the predetermined time period; and
tuning a radio frequency (RF) resource of the mobile communication device to a second subscription of the mobile communication device before the predetermined time period expires in response to determining that the first subscription should be de-prioritized before the predetermined time period expires.

18. The non-transitory processor-readable storage medium of claim 17, wherein the emergency message comprises an Earthquake and Tsunami Warning System (ETWS) message or a Commercial Mobile Alert System (CMAS) message.

19. The non-transitory processor-readable storage medium of claim 17,
wherein the emergency message comprises repeated transmissions of one or more message segments, and
wherein the stored processor-executable instructions are configured to cause the processor of the mobile communication device to perform operations such that determining whether the first subscription should be de-prioritized before the predetermined time period expires based on the reception history of the first subscription during the predetermined time period comprises:
decoding each received message segment;
incrementing an associated counter by the processor for each message segment that is successfully decoded;
determining whether counters associated with each message segment are each greater than or equal to a threshold; and
tuning the RF resource to the second subscription before the predetermined time period expires in response to determining that the counters associated with each message segment are all greater than or equal to the threshold.

20. The non-transitory processor-readable storage medium of claim 19, wherein the stored processor-executable instructions are configured to cause the processor of the mobile communication device to perform operations further comprising:
receiving additional repeated transmissions of the one or more unique message segments in response to determining that the counters associated with each message segment are not each greater than or equal to the threshold.

21. The non-transitory processor-readable storage medium of claim 17,
wherein the emergency message comprises one or more message segments, and
wherein the stored processor-executable instructions are configured to cause the processor of the mobile communication device to perform operations such that determining whether the first subscription should be de-prioritized before the predetermined time period expires based on the reception history of the first subscription during the predetermined time period comprises:
determining whether a decodable message segment is received during a current frame;
incrementing a counter in response to determining that no decodable message segment is received during the current frame;
determining whether the counter is greater than or equal to a threshold; and
tuning the RF resource to the second subscription before the predetermined time period expires in response to determining that the counter is greater than or equal to the threshold.

22. The non-transitory processor-readable storage medium of claim 21, wherein the stored processor-executable instructions are configured to cause the processor of the mobile communication device to perform operations further comprising:
resetting the counter in response to determining that a decodable message segment is received during the current frame.

23. The non-transitory processor-readable storage medium of claim 21, wherein the counter is maintained by a physical layer of the RF resource.

24. The non-transitory processor-readable storage medium of claim 17, wherein the predetermined time period is based on a discontinuous reception scheduling mode of a network associated with the first subscription.

25. A mobile communication device, comprising:
a radio frequency (RF) resource;
means for prioritizing a first subscription of the mobile communication device for a predetermined time period in order to receive an emergency message;
means for determining whether the first subscription should be de-prioritized before the predetermined time period expires based on a reception history of the first subscription during the predetermined time period; and
means for tuning the RF resource to a second subscription of the mobile communication device before the predetermined time period expires in response to determining that the first subscription should be de-prioritized before the predetermined time period expires.

26. The mobile communication device of claim 25, wherein the emergency message comprises an Earthquake and Tsunami Warning System (ETWS) message or a Commercial Mobile Alert System (CMAS) message.

27. The mobile communication device of claim 25,
wherein the emergency message comprises repeated transmissions of one or more message segments, and
wherein means for determining whether the first subscription should be de-prioritized before the predetermined time period expires based on the reception history of the first subscription during the predetermined time period comprises:
means for decoding each received message segment;
means for incrementing an associated counter by the processor for each message segment that is successfully decoded;
means for determining whether counters associated with each message segment are each greater than or equal to a threshold; and
means for tuning the RF resource to the second subscription before the predetermined time period expires in response to determining that the counters associated with each message segment are all greater than or equal to the threshold.

28. The mobile communication device of claim 27, further comprising:
means for receiving additional repeated transmissions of the one or more unique message segments in response to determining that the counters associated with each message segment are not each greater than or equal to the threshold.

29. The mobile communication device of claim 25,
wherein the emergency message comprises one or more message segments, and
wherein means for determining whether the first subscription should be de-prioritized before the predetermined time period expires based on the reception history of the first subscription during the predetermined time period comprises:
means for determining whether a decodable message segment is received during a current frame;
means for incrementing a counter in response to determining that no decodable message segment is received during the current frame;
means for determining whether the counter is greater than or equal to a threshold; and
means for tuning the RF resource to the second subscription before the predetermined time period expires in response to determining that the counter is greater than or equal to the threshold.

30. The mobile communication device of claim 29, further comprising:
means for resetting the counter in response to determining that a decodable message segment is received during the current frame.
